(19) United States
(12) Patent Application Publication
(10) Pub. No.: US 2014/0287158 A1
(43) Pub. Date: Sep. 25, 2014

(54) PERFORMANCE OF CONDUCTIVE COPPER PASTE USING COPPER FLAKE

(71) Applicant: Intrinsiq Materials, Inc., Rochester, NY (US)

(72) Inventors: Janet Heyen, Rochester, NY (US); Michael Carmody, Webster, NY (US)

(73) Assignee: Intrinsiq Materials, Inc., Rochester, NY (US)

(21) Appl. No.: 14/219,047

(22) Filed: Mar. 19, 2014

Related U.S. Application Data
(60) Provisional application No. 61/803,839, filed on Mar. 21, 2013.

(51) Int. Cl. C09D 5/24

(52) U.S. Cl. CPC C09D 5/24
USPC 427/555; 252/512

(57) ABSTRACT

A conductive paste for screen application has a mixture of copper flake having a mean diameter between 1.0-8.0 micrometers and copper nanoparticles having a mean diameter from 10 nm to 100 nm, wherein the ratio of the copper flake to the nanoparticles is between 2:1 and 5:1 by weight; and a resin comprising about half of a polymer having a molecular weight in excess of 10,000 and one or more solvents.

### CROSS-REFERENCE TO RELATED APPLICATIONS

This application claims the benefit of U.S. Provisional Patent Application Ser. No. 61/803,839, filed on 21 Mar. 2013, entitled “Improving Performance of Conductive Copper Paste Using Copper Flake” in the names of Janet Heyen et al., the contents of which are incorporated fully herein by reference.

### FIELD OF THE INVENTION

The invention relates generally to materials that are applied to a substrate and treated to form a conductive pattern thereon, and more particularly relates to a conductive copper paste formulation that uses a combination of metal flake and nanoparticle materials for forming conductive traces.

### BACKGROUND OF THE INVENTION

Fabrication of mass-produced electronic items typically involves temperature- and atmosphere-sensitive processing. Conventional material deposition systems for electronic fabrication, including plasma-enhanced chemical vapor deposition (PECVD) and other vacuum deposition processes, rely on high temperatures and rigidly controlled ambient conditions. Conventional processes are typically subtractive, applying a conductive or other coating over a surface, treating the coating to form a pattern, then removing unwanted material. The conventional method for forming copper traces is one example of this process, requiring multiple processing steps, with the use of toxic chemicals and the complications and cost of proper waste disposal.

There is considerable interest in migrating to cheaper, lighter, more flexible substrates such as polyethylene teraphthalate (PET) and the use of additive printing processes that reduce waste and environmental damage.

Recent advances in printed electronics provide solutions that reduce the cost, complexity, and energy requirements of conventional deposition methods and expand the range of substrate materials that can be used. For printed electronics, materials can be deposited and cured at temperatures compatible with paper and plastic substrates and can be handled in air. In particular, advances with nanoparticle-based inks, such as silver, copper, and other metal nanoparticle-based inks, for example, make it feasible to print electronic circuit structures using standard additive printing systems such as inkjet and screen printing systems. Advantageously, nanoparticle-based inks have lower curing temperatures than those typically needed for bulk curing where larger particles of the same material are used.

A number of methods have been used for deposition of the conductive material in suitable patterns on different types of substrates. Among methods used are ink-jet printing, screen printing, and various other printing methods. Various formulations have been used for providing conductive inks and pastes that can be printed onto the substrate, using different formulations of metal powders and other materials.

Nanoparticulate copper and other conductive metals have shown considerable promise as candidate materials for conductive inks and pastes. These materials are applied to the substrate in an additive manner, then cured by sintering, localized application of intense heat that tends to bond adjacent particles to each other to form conductive paths.

While some progress has been made in demonstrating suitable performance and commercial applicability of additive methods for forming a pattern of conductive traces, results thus far have shown that there is room for improvement. Among aspects of improvement needed are the following:
(i) Adhesion. There must be good adhesion between the applied material and the substrate before and after sintering.
(ii) Response to sintering energy. Because of the high localized energy levels required for sintering, cracking and delamination have been persistent problems for curing the applied materials. The heat that is generated during sintering resides in the trace for only very short intervals (e.g. less than one millisecond), favorable for allowing the use of inks and pastes on temperature-sensitive plastic substrates. However, the heat that is generated can decompose and vaporize polymers in the applied paste, including polymers used to coat the nanoparticles and polymers used as binder. Venting of the resulting vapor can cause bubbling and cracking in the surface of the sintered trace, detrimental to good adhesion. In addition, substrates with very low glass transition (Tg) temperatures, such as polyethylene terephthalate (PET), can slightly deform under localized heat conditions. This dimensional instability can, in turn, introduce stresses in the sintered copper traces and cause cracks and delamination from the substrate and poor conductivity.
(iii) Curing efficiency. Conventional methods of curing conductive pastes include oven-curing, with use of high-energy illumination sources, such as Xenon bulbs, that can be relatively inefficient, causing wasted heat energy. The generated heat energy with such sources is broadly distributed, rather than being focused on the deposited ink. This is inefficient, since not all of the heat energy is used. In using such methods, the full surface of the substrate must also be heated to the temperatures needed to cure the trace. The needed levels of heat energy for this purpose can cause degradation of the substrate and effectively restricts the substrates that can be used, preventing the use of many types of plastics and other flexible and less costly substrates.
(iv) Substrate options. As noted earlier, PET is one type of less expensive substrate material that offers reduced waste and environmental impact. However, forming conductive traces on PET and other plastics remains challenging due to heat problems. Exemplary substrates include plastics, textiles, paper, sheet materials, and other materials that provide a suitable surface for depositing a pattern of nanoparticle-based ink.
(v) Performance. For industry acceptance and commercial viability, conductivity of the applied traces needs to be as low as 3× bulk or better. Alternatively stated, resistivity of the applied circuit traces must be sufficiently low to compare with the resistivity of pure copper traces formed using conventional subtractive photo-etchant methods. Conventionally formed copper traces have a resistivity of about 1.7 μΩcm; this provides a reference value against which relative conductivity of an applied ink or paste material is compared. The “bulk ratio” is a multiple of this resistivity and is used as a practical measure of how well a conductive trace performs. In conventional practice as of the date of this application, printed traces formed from nanoparticle copper have been shown to achieve bulk ratios no better than about 6 (that is, no lower than 6 times 1.7 μΩcm). The desired levels of conductivity/resistivity can be difficult to achieve with current processes/ink formulations. There is also motivation to reduce the costs associated with formulation, printing, and conditioning of conductive inks.
(vi) Resolution. Higher resolution, using thinner conductive traces and allowing higher density of traces, is difficult to achieve with inefficient curing processes, due to factors such as surface distortion because of excess heat, for example.
   Factors (i) to (vi) given above are only some of the areas of improvement that are of interest to those who are developing and using printed conductive traces. Thus, it can be seen that improvement with respect to any of factors (i)-(vi) would help to make printing of conductive traces more commercially viable as an alternative to conventional photolithographic etching methods.

### SUMMARY OF THE INVENTION

The present invention is directed to overcoming one or more of the problems set forth above. Briefly summarized, according to one aspect of the present invention, there is provided a conductive paste for screen application, the conductive paste comprising:
a mixture of copper flake having a mean diameter between 1.0-8.0 micrometers and copper nanoparticles having a mean diameter from 10 nm to 100 nm, wherein the ratio of the copper flake to the nanoparticles is between 2:1 and 5:1 by weight;
and
a resin comprising about half of a polymer having a molecular weight in excess of 10,000 and one or more solvents.

Embodiments of the present invention have been shown to exhibit enhanced sintering latitude over conductive pastes having conventional formulations.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings.

FIG. 1 is a graph showing sintering latitude for conductive traces with the formulation of an embodiment of the present invention.

FIG. 2A is a micrograph showing a portion of a conductive trace formulated using conventional metal powder.

FIG. 2B is a micrograph showing a portion of a conductive trace from a formulation according to an embodiment of the present invention.

### DETAILED DESCRIPTION OF THE INVENTION

The following is a detailed description of the preferred embodiments of the invention, reference being made to the drawings in which the same reference numerals identify the same elements of structure in each of the several figures. It is understood that the elements not shown specifically or described may take various forms well know to those skilled in the art.

Where they are used, the terms “first”, “second”, and so on, do not necessarily denote any ordinal or priority relation, but may be used for more clearly distinguishing one element or time interval from another.

In the context of the present disclosure, the terms “ink” and “paste” are used equivalently and are terms of art that broadly apply to materials that are deposited in a pattern on a substrate in a viscous, generally fluid or paste form and are sintered and otherwise cured after deposition and drying by applying a curing energy such as heat or light energy. Sintering is a curing process by which curing energy effects a structural change in the composition and/or arrangement of particles in the ink or paste. A conductive paste may or may not be conductive when formulated and may require application and sintering for conductivity.

Curing may also have additional aspects for ink or paste conditioning, such as sealing or removal of organic coatings or other materials that are provided in the initial formulation but not wanted in the final, printed product. In the context of the present invention, the term “curing” is used to include drying, sintering, and any post-sintering processing as well as other curing processes that employ the applied radiant energy for conditioning the deposited ink or paste.

The terms “nanoparticle-based material”, “nanoparticle-based ink”, “nanoparticle-based paste”, “nanoparticle material”, “nanoparticle ink” or “nanoparticulate material” refer to an ink or paste or other applied viscous fluid that has an appreciable amount of nanoparticulate content, such as more than about 5% by weight or volume.

In the context of the present invention, the term “substrate” refers to any of a range of materials upon which the nanoparticle ink or paste is deposited for curing. Exemplary substrates include plastics, textiles, paper, sheet materials, and other materials that provide a suitable surface for depositing a pattern of nanoparticle-based ink or paste. Substrates can be flexible or rigid.

In the context of the present invention, the term “copper flake” or, more generally “metal flake” refers to metal particles provided as a powder having a mean diameter from 1.0 to 8.0 micrometers; the range from 1.0 to about 5.0 micrometers appears to be particularly advantageous.

As used herein, the term “energizable” relates to a device or set of components that perform an indicated function upon receiving power and, optionally, upon receiving an enabling signal.

Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Embodiments of the present invention provide a formulation that has been shown to provide improved adhesion and performance of sintered traces for conductive pastes. In working with nanoparticle-based inks and pastes, the inventors have observed a number of improvements in materials application and performance due to characteristics of nanoparticle arrangement, but recognize that there are still areas requiring improvement with respect to various aspects of ink and paste formulations and process performance. It has been widely held that nanoparticle materials represent a step forward in providing conductive inks and pastes, due to favorable characteristics of the nanoparticle such as proportion of surface area to overall mass. Thus, researchers have been attempting to formulate conductive pastes that are predominantly nanoparticle-based and have directed considerable efforts in obtaining nanoparticles of optimal size for this purpose. Counter-intuitively, the inventors have found that mixture of some amount of nanoparticle materials with a larger amount of metal flake can provide improvements in circuit trace preparation, particularly with respect to sintering response and performance.

### Formulation

The basic conductive paste formulation includes particulate copper and resin components. For the copper component, embodiments of the present invention use a formulation with some amount or combination of copper nanoparticles coated with a polymer or copper/copper-oxide nanoparticles that have a copper core with a CuO (copper oxide) shell. An amount of copper flake is also used, with particle sizes much larger than nanoparticle range, such as from 1 to about 8 micrometers on average. For the resin component, additional dispersant, about 8% PVP (Polyvinylpyrrolidone) according to one embodiment of the present invention, is also used, along with a solvent that has some amount of a sintering enhancer, such as about 5 weight % of glycerol. Glycerol, with a vapor pressure of about 1 mm at 20 degrees C., appears to work well as a solvent component.

Among the numerous solvents that can be used in addition to or in place of glycerol are 1-methoxy-2-propanol, diethylene glycol, diethylene glycol monoethylether, diethylene glycol monobutyl ether, diethylene glycol monoethylether acetate, diethylene glycol monobutylether acetate, cyclohexanol, and 2-methyl-2,4-pentanediol. Alternately, some other solvent having a high boiling point above about 200 degrees C. and a low vapor pressure below about 2 mm mercury at 20 degrees C. can be used, with a liquid or solid sintering enhancer in place of some or all of the glycerol content. Alternative sintering agents can include solid additives that may be non-volatile but are vaporized when sintering energy is applied.

Optionally, various glass frit materials may also be incorporated in amounts from 0.5 to 5 weight % of the paste. These are materials which are well known in printed electronics and may be obtained from vendors such as Asahi Glass, Ceradyne, or others. Useful frit materials have mean particles sizes which can range from 1 to 10 microns.

Polymer encapsulated copper nanoparticles are familiar to those skilled in nanoparticle applications and are described in commonly assigned U.S. Patent Application No. 2014/0009545 entitled “Conductive ink formulas for improved inkjet delivery” by Carmody, the contents of which are incorporated herein by reference in its entirety.

The binder or coating in the resin formulation helps to prevent agglomeration and to thereby maintain the high ratio of surface area to particle mass, which confers many of the advantageous properties of nanoparticles. Binders that can be used include, but are not limited to, polyvinyl acetate such as VINNAPAS B60™ polyvinyl acetate; polyvinyl butyral resin such as Butvar B79™ polyvinyl butyral resin; BYK 4509™ or other salt of a polymer with acidic groups, a polyacrylate-based surface additive such as BYK 354™ polyacrylate-based surface additive; Elvacite 2044™ n-butyl methacrylate polymer; an acrylic resin, such as Elvacite 2028™ acrylic resin; ethyl cellulose; or similar polymers. (Elvacite® is a registered trademark of Lucite International, Inc.; VINNAPAS is a registered trademark of Wacker Chemie AG; Butvar is a registered trademark of Eastman Chemical Co.; BYK is a registered trademark of Altana.)

The nanoparticles used in the ink formulation can be between 0.5-500 nm. Advantageously, therefore, the present invention can be implemented for a wide range of nanoparticle pastes including those with a significant amount of larger copper particles which are often cheaper to produce, but do not otherwise work well for forming conductive traces.

For inventive formulations, the ratio of copper flake to nanoparticle copper is in the range from 2:1 to 5:1 by weight. One source of suitable copper flake is product CU 101 from Atlantic Equipment Engineers, Bergenfield, N.J. The mean diameter of the polymer-coated nanoparticles can vary between about 10 nm and 100 nm.

### EXAMPLE 1

### Comparative Paste A

Into a porcelain bowl was weighed 36.0 g of amorphous copper powder of mean diameter 4.5-7.0 micrometers (Cu CH UF 10 from Ecka Granules GmbH) and 9.0 g of polymer-coated copper nanoparticles of mean diameter 50 nm. To these powders was added 2.5 g of a resin consisting of 1.25 g of 40,00 C0 molecular weight polyvinlypyrrolidone (PVP), 1.0 g of ethylene glycol (EG), and 0.25 g of diacetone alcohol. The mixture was kneaded with a spatula until a thick paste was obtained. This paste was further mixed on a three roll mill until a uniform viscous paste was obtained.

### Inventive Paste A

This paste was prepared as Comparative A above except that 36.0 g of copper flake with a mean diameter of 1.0-5.0 micrometers was used in place of the amorphous copper. One source of suitable copper flake is product CU 101 from Atlantic Equipment Engineers, Bergenfield, N.J.

The ratio of copper flake to nanoparticle copper is in the range from 2:1 to 5:1 by weight. The mean diameter of the polymer-coated nanoparticles can vary between about 10 nm and 100 nm.

The resin component of the paste is about half of:
(i) a polymer having a molecular weight in excess of 10,000 number average; and
(ii) one or more solvents.

Polymers with weight number average of about 40,000 (40,000+/−10%) work well. The ratio of the polymer to the combined solvents is preferably 1:1 but can be between about 0.5:1 and 1.5:1.

Glass frit materials may also be incorporated from 0.5 to 5 weight %, as noted above.

### Photonic Sintering of Pastes

Traces measuring 1 mm wide by 48 mm long were screen printed using Comparative paste A and Inventive paste A onto a laser brochure paper manufactured by Hewlett Packard, The printed samples were dried in a vacuum oven for an hour and photonically sintered using a Xenon Sinteron 2000 flash system as the radiant energy source.

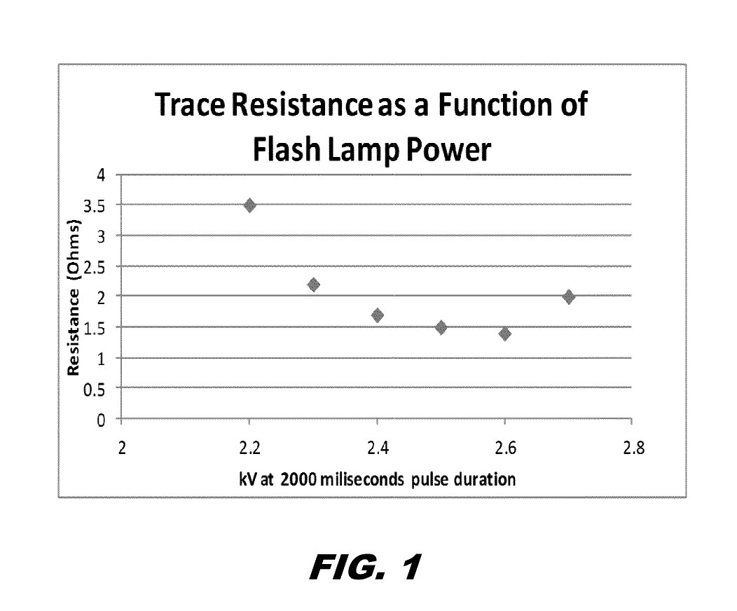

To measure sintering latitude, flash lamp intensity was varied for individual traces through a range beginning when resistance of a printed line could be first measured with a standard laboratory quality hand-held ohmmeter, and ending when no further resistance could be measured due to cracking or delamination. Plots were made of the measured trace resistance as a function of the voltage (or energy in Joules) supplied to the flash lamp. This range is termed the Sintering Latitude and relates to the relative usability of the paste and its response over a range of possible sintering energy levels (see FIG. 1). A larger sintering latitude indicates a conductive printed material with more favorable working properties for production conditions. Relative adhesion levels and overall performance of the material, such as low bulk resistivity, relate directly to the sintering latitude.

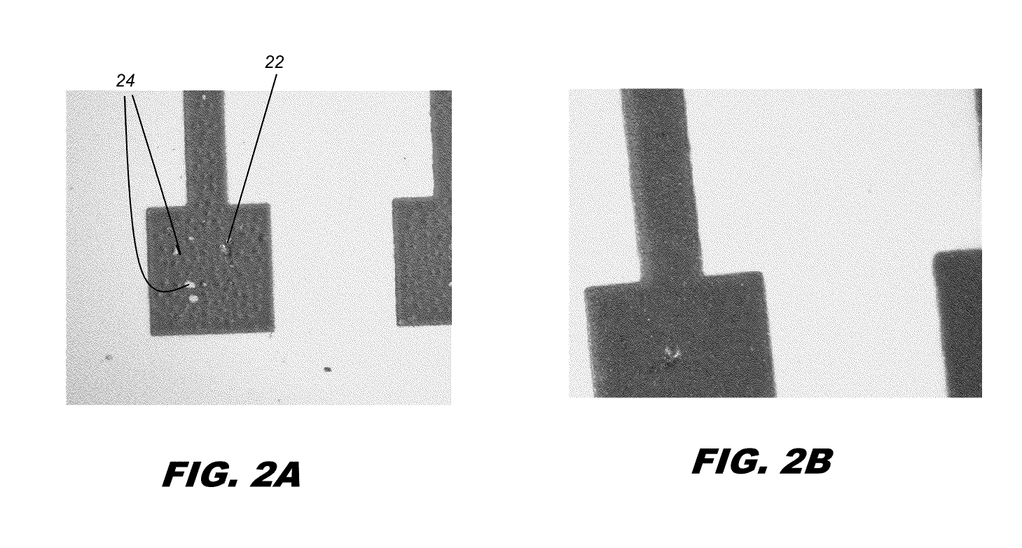

Sintered traces were examined microscopically. Representative images are shown in FIGS. 2A and 2B. FIG. 2A shows a representative portion of a printed trace for the Comparative A formulation. Sintered traces for Comparative Paste A made from amorphous micron copper show bubbles 22, pitting 24, and cracks from vented vapors. FIG. 2B shows representative results for the Inventive A paste formulation, with much smoother and more uniform sintered trace features. The inventive paste A formulation shows noticeably fewer bubbles, dramatically reduced pitting, and negligible cracking from venting or stress. As predicted by the improved sintering latitude, adhesion of the Inventive A paste formulation was improved over that for the Comparative A paste, following curing.

### EXAMPLE 2

Inventive Paste B was prepared in the same way as Comparative A above, except that a flaked copper of mean particle size of 4.0-13 microns was used in place of the amorphous copper.

Inventive Paste C was similarly prepared to Inventive Paste B except that glycerol was added to the resin in place of a percentage of the other solvents such that the weight percentage of glycerol in the final paste was about 2%.

Comparative A and Inventive B and C were printed and sintered as above except that they were printed onto DuPont Melinex® 505 polyester film which is a temperature sensitive substrate. The sintering latitudes observed are shown in Table 1.

TABLE 1
Sintering Latitudes for Example 2

| | | Sintering Latitude |
|---|---|---|
| Paste | Micro Copper Type | (Joules) |
| Comparative A | Amorphous | 0 |
| Inventive B | Flake | 378 |
| Inventive C | Flake | 331 |

It can be seen from Inventive Pastes B and C that using copper flake in lieu of amorphous micron copper results in much larger sintering latitudes, making these materials more easily workable under production conditions and providing improved performance of cured features. Marked improvement in sintering latitude resulted with copper flake having mean diameter from 1.0 to 8.0 microns.

### EXAMPLE 3

### Comparative Paste B

Into a porcelain bowl was weighed 30.8 g of amorphous copper powder of mean diameter 4.5-7.0 micrometers (Cu CH UF 10 from Ecka Granules GmbH), 15.2 g of copper nanoparticles of mean diameter 40 nm, 5.8 g of a resin consisting of 2.9 g of 40,000 molecular weight polyvinlypyrrolidone (PVP), 2.3 g of ethylene glycol (EG), and 0.6 g of diacetone alcohol and 1.25 g of glass frit (DPS 149 from Asahi Glass Corp). The mixture was kneaded with a spatula until a thick paste was obtained. This paste was further mixed on a three roll mill until a uniform viscous paste was obtained.

### Inventive Paste D

This paste was prepared as Comparative A above except that 30.8 g of copper flake with a mean diameter of 1.0-5.0 micrometers (CU 101 from Atlantic Equipment Engineers, Bergenfield, N.J.) was used in place of the amorphous copper.

### Inventive Paste E

This paste was prepared as Comparative A above except that 30.8 g of copper flake of mean particle size of 4.0-13 microns was used in place of the amorphous copper.

Inventive pastes D and E can have from 0.5 to about 5% of glass frit.

### Photonic Sintering of Pastes

A pattern of conductive lines measuring 1 mm wide by 48 mm long were screen printed using Comparative paste B and Inventive pastes D and E onto glass plates, dried in a vacuum oven for an hour, and photonically sintered using a LAPS-60 laser sintering system which incorporates an 808 nm laser diode as radiant energy source. Radiant energy for sintering was varied by changing both the current to the laser as well as the scan speed. Energy input was increased through a range beginning when resistance of a printed line could be first measured with a hand-held ohmmeter, and ending when no further resistance could be measured due to cracking or delamination Minimum resistances achieved for each paste was compared, with results as given in Table 2.

TABLE 2
Minimum Resistance for Example 3

| Paste | Micro Copper Type | Minimum Resistance (Ω) |
|---|---|---|
| Comparative B | Amorphous | 2.9 |
| Inventive D | Flake | 2.2 |
| Inventive E | Flake | 2.8 |

It can be seen from Inventive Pastes D and E that using copper flake in lieu of amorphous micron copper results in lower achievable resistance, making target resistivity performance easier to reach.

### EXAMPLE 4

Paste formulations as described previously in Comparative A, Inventive A and Inventive B were made and evaluated multiple times over a 6 month period. Printing was on DuPont Melinex® 505 polyester film. Sintering latitude, defined as the energy range over which the demonstrated resistance is within a fixed percentage of the minimum resistance, was compared over that time period. Results are as shown in Table 3.

TABLE 3
Sintering Latitude Performance for Example 4

| | | Average Latitude | Average Latitude |
|---|---|---|---|
| | Number of | on HP Brochure | on Dupont Melinex |
| Paste | observations | Paper (Joules) | 505 (Joules) |
| Comparative A | 8 | 175 | 106 |
| Inventive A | 21 | 241 | 184 |
| Inventive B | 7 | 333 | 333 |

Both inventive formulas demonstrated greater sintering latitude on the film substrate than did the pastes made with amorphous copper.

### EXAMPLE 5

As illustrated in FIG. 2A, the sintering process may result in bubbling, pitting and cracks, detectable when examined microscopically. Pastes formulated as described as Comparative A, Inventive A and Inventive B were made and sintered multiple times over a 6 month period. The sintered material that resulted in the lowest achieved resistance was examined under a microscope for the severity of bubbles and surface disruption. The severity was assigned to a numerical scale in which “0” showed no bubbles, “2” showed texture but no physical breaks in the surface and “5” had a high frequency of large bubbles or voids in the copper.

Table 4 shows the relative average bubble severity over this time period, where the lower the severity, the better the uniformity of the sintered material.

TABLE 4
Average Bubble Severity Comparison for Example 5

| | | Average Bubble | Average Bubble |
|---|---|---|---|
| | Number of | Severity on HP | Severity on Dupont |
| Paste | observations | Brochure Paper | Melinex 505 |
| Comparative A | 7 | 3.7 | 2 |
| Inventive A | 44 | 0.7 | 0.7 |
| Inventive B | 17 | 3 | 1.1 |

These data indicate that the inventive pastes are marginally to significantly advantaged in producing an undamaged trace when sintered to a minimum resistance.

The experimental data shows that using copper flake in combination with nano copper particles in conductive screen paste formulated according to an embodiment of the present invention confers some useful benefits. First, the physical integrity of the tracks when printed and sintered can be improved such that small cracks and bubbles are less likely. Secondly, the adhesion on temperature sensitive substrates such as PET can be improved. Sintering latitude also shows significant improvement with substitution of copper flake in place of amorphous copper.

Thus, it can be seen that embodiments of the present invention provide a conductive paste that is well suited for screen application, the conductive paste comprising a 2:1 to 5:1 mixture of copper flake to polymer-coated nanoparticles of mean diameter 10 nm-100 nm; and a resin comprising about half of a solvent and a polymer having a molecular weight in excess of 10,000, such as PVP.

While the experimental data shows successful results for formulations that use copper nanoparticles and copper metal flake, this process can be extended to other metals and elements for forming conductive and semiconductive patterns. The printed electronic structures that can be formed by the present method are made of a metal such as copper or semi-metal, such as semiconductor material. Suitable metals for printing and curing in a pattern include, but are not limited to, copper, gold, silver, nickel, palladium, platinum and other metals and alloys. Semi-metal materials including silicon and alumina can also be used. Furthermore, silicon particles that have been doped to provide semiconducting behavior (for example, doped with phosphorous or arsenic) are also suitable.

Therefore, the present method can be used in production of both electronic structures, such as connecting traces between devices, and semiconducting devices themselves. For each of these materials, solvent mixture, ink deposition, and sintering processes would follow similar formulations and steps, with corresponding changes according to the conductive or semiconductor materials used.

Sintering can be performed using Xenon flash illumination or using other radiant energy sources, such as laser light sources. Methods for sintering using patterned laser illumination are described, for example, in commonly assigned U.S. Patent Application Publication No. 2013/0337191 entitled “Method for depositing and curing nanoparticle-based ink using spatial light modulator” by Ramanujan et al., incorporated herein by reference in its entirety.

The use of laser light allows for the selection of a light wavelength that is well suited for the sintering of the nanoparticles while eliminating or minimizing damage to the coating. By using lasers, monochromatic light can be applied to the conductive paste at wavelengths most favorable to sintering and other curing functions, without contributions from other wavelengths, such as lower wavelength light that can be heavily absorbed in the upper layers of deposited material. Absorption of wavelengths in upper layers of the material nearest the surface can cause these upper layers to be inadvertently sealed, trapping binder and other materials that must be removed from beneath the surface. Advantageously, laser illumination provides sufficient energy for the removal of component materials in the precursor nanomaterial. This includes materials useful for improving ink application but not wanted in the final product, such as organic binders and particle coatings. With laser light, the spectral content and intensity can be specified and controlled so that the laser delivers the proper energy to the applied material, at the proper depth. In this way, problems such as unwanted sealing of top layers can be avoided.

### Substrate Considerations

Thermal characteristics of the substrate can complicate the task of sintering in a number of ways when conventional Xenon flash energy is used. Substrates having relatively high thermal conductivity, such as aluminum, silicon, and ceramic substrates, for example, can conduct the needed heat away from the area of incident light before sintering energy levels are reached. Polymer-based substrates, such as ITO coated plastic substrates, can be damaged due to the higher thermal conductivity of the ITO coating. Embodiments of the present invention help to address problems related to thermal response by using laser light that can be focused onto a small area.

It is found that the present method is particularly suitable for a number of substrates including PET (polyethylene terephthalate), PI (Polyimide), PE (polyethylene), PP (Polypropylene), PVA (poly-vinyl alcohol), SiN (silicon nitride), ITO (indium tin oxide) and glass. On such substrates, the present application provides an improved method for producing high resolution lines compared to other systems. Particularly when used with laser illumination, the direct transformation (curing, sintering or otherwise) of the material by the laser energy allows for higher resolution features, reduces or avoids the need for adding further layers such as photoresist layers, and requires fewer stages to produce than do conventional methods. Printing and curing of electronic materials and components can be performed at low volumes as well as for large-scale, high volume production.

In general, substrates need to be sufficiently clean in order to fully accept and cure the printed ink materials. Failure to clean the substrate prior to printing can lead to poor adhesion, degraded electrical performance, material contamination, and breakage. Cleaning of the substrate can be performed using suitable solvents, or alternately with surface treatments such as using corona discharge energy or treating with compressed gases or other methods.

Embodiments of the present invention advantageously allow high resolution features to be produced in a single stage process. In particular, the invention avoids the need for an extra layer, such as a photoresist layer, and its subsequent processing. Furthermore, unlike photoresist methods, the method of the present invention does not require the use of etchants to remove the unprotected, uncured structure. This is advantageous as it simplifies the production process and greatly reduces costs related to waste handling.

The invention has been described in detail with particular reference to certain preferred embodiments thereof, but it will be understood that variations and modifications can be effected within the scope of the invention.

What is claimed is:

1. A conductive paste for screen application, the conductive paste comprising:
a mixture of copper flake having a mean diameter between 1.0-8.0 micrometers and copper nanoparticles having a mean diameter from 10 nm to 100 nm, wherein the ratio of the copper flake to the nanoparticles is between 2:1 and 5:1 by weight;
and
a resin comprising about half of a polymer having a molecular weight in excess of 10,000 and one or more solvents.

2. The conductive paste of claim 1 wherein the polymer is taken from the group consisting of: polyvinlypyrrolidone, polyvinyl acetate; polyvinyl butyral resin, a salt of a polymer with acidic groups, a polyacrylate-based surface additive, an n-butyl methacrylate polymer; an acrylic resin, and ethyl cellulose.

3. The conductive paste of claim 1 wherein the one or more solvents are taken from the group consisting of: ethylene glycol, diacetone alcohol, 1-methoxy-2-propanol, diethylene glycol, diethylene glycol monoethylether, diethylene glycol monobutyl ether, diethylene glycol monoethylether acetate, diethylene glycol monobutylether acetate, cyclohexanol, and 2-methyl-2,4-pentanediol.

4. The conductive paste of claim 1 wherein the copper flake has a mean diameter of 5.0 micrometers or less.

5. The conductive paste of claim 1 wherein the copper nanoparticles comprise polymer-coated nanoparticles.

6. The conductive paste of claim 1 wherein the copper nanoparticles comprise copper-oxide nanoparticles that have a copper core with a CuO shell.

7. The conductive paste of claim 1 further comprising from 0.5-5% by weight of glass frit.

8. The past of claim 7 wherein the glass frit has mean particle sizes ranging from 1 to 10 microns.

9. A conductive paste for screen application, the conductive paste comprising:
a mixture of copper flake having a mean diameter between 1.0-8.0 micrometers and copper nanoparticles having a mean diameter from 10 nm to 100 nm, wherein the ratio of the copper flake to the nanoparticles is between 2:1 and 5:1 by weight;
a resin comprising about half of a polymer having a molecular weight of about 40,000 and one or more solvents;
and
from 0.5 to 5% by weight of glass frit.

10. A method for forming a pattern of conductive traces on a substrate, the method comprising:
forming a conductive paste for screen application, the conductive paste comprising a mixture of copper flake having a mean diameter between 1.0-8.0 micrometers and copper nanoparticles having a mean diameter from 10 nm to 100 nm, wherein the ratio of the copper flake to the nanoparticles is between 2:1 and 5:1 by weight; and further comprising a resin comprising about half of a polymer having a molecular weight in excess of 10,000 and one or more solvents;
applying the pattern of conductive paste to the substrate;
and
curing the pattern of conductive paste using a radiant energy source.

11. The method of claim 10 wherein the radiant energy source is a laser.

12. The method of claim 10 wherein applying the pattern of conductive paste comprises using screen printing.

13. The method of claim 10 wherein the conductive paste further comprises from 0.5 to 5% by weight of glass frit.

14. The method of claim 10 wherein the substrate is taken from the group consisting of polyethylene terephthalate, polyimide, polyethylene, polypropylene, poly-vinyl alcohol, silicon nitride, indium tin oxide, and glass.

15. The method of claim 10 wherein the applied pattern of conductive paste has a sintering latitude in excess of 180 joules.
